(19) United States
(12) Patent Application Publication
(10) Pub. No.: US 2008/0126319 A1
(43) Pub. Date: May 29, 2008

(54) Automated short free-text scoring method and system

(76) Inventors: Ohad Lisral Bukai, Washington, DC (US); Robert Pokorny, Olney, MD (US); Jacqueline A. Haynes, Potomac, MD (US)

Correspondence Address: EPSTEIN & GERKEN, 1901 RESEARCH BOULEVARD, SUITE 340, ROCKVILLE, MD, 20850, US

(21) Appl. No.: 11/895,267

(22) Filed: Aug. 23, 2007

Related U.S. Application Data
(60) Provisional application No. 60/840,320, filed on Aug. 25, 2006.

(51) Int. Cl. G06F 17/30

(52) U.S. Cl. 707/3; 707/E17.108

(57) ABSTRACT

The present invention uses an algorithm which evaluates learners' short free-text answers when the answer has as few as 10 words. The answer key uses only one correct answer, allowing instructors to ask learners to produce short open-ended text responses to questions. The algorithm automates the scoring of free-text answers, enabling instructors to embed such questions in online courses, and providing nearly immediate scoring and feedback on learners' responses. The algorithm is based on the semantic relatedness of the words in the learners' answer to the single correct answer. The semantic relatedness algorithm requires a dedicated domain specific index or collection of topic-focused documents (a corpus), which is created by an automated crawl mechanism that collects documents based upon descriptive domain keywords.

### CROSS-REFERENCE TO RELATED PATENT APPLICATION

This application claims priority from prior U.S. provisional patent application Ser. No. 60/840,320 filed Aug. 25, 2006, the entire disclosure of which is incorporated herein by reference.

### BACKGROUND OF THE INVENTION

1. Field of the Invention

The present invention relates to automated short free-text scoring methods and systems for online assessment for development, delivery and automated scoring of free-text and multimedia assessment items.

2. Discussion of the Related Art

Training and assessment can benefit from advanced technology that evaluates free-text answers. For example, ETS (Educational Testing Service) uses a computerized assessment system to score free-text answers. ETS's method is a very elaborate process, using many examples of good and poor answers to train the computerized assessment system. Although ETS doesn't describe its algorithm, other research groups describe the algorithm they use to perform similar functions. One research group which describes its methods and its underlying algorithm is headed by Thomas Landauer, and applies Latent Semantic Analysis (LSA) to free-text assessment. While ETS's method and LSA are both excellent examples of using advanced technology to assess free-text, both of these approaches require text that is the length of two or more average paragraphs: LSA researchers recommend that LSA should be applied to answers with at least 200 words, and ETS applies its assessment scheme to essays written for college entrance exams which will typically fill a page or more.

Many computerized assessment models have been used to assess free-text. Project Essay Grade (PEG), the most classic assessment model, was developed by Page and Peterson (Page, E. B. and Petersen, N. S. (1995), “The computer moves into essay grading”, Phi Delta Kappan, March, 561-565), and focused on linguistic features of essay documents. E-RATER, developed by Bernstein and used by ETS, applies a hybrid approach combining linguistic features, derived by using Natural Language Processing (NLP) techniques, with other document structure features. A model developed by Larkey (Larkey, L. S. (1998), “Automatic essay grading using text categorization techniques”, Proceedings of the Twenty First Annual International ACM SIGIR Conference on Research and Development in Information Retrieval, Melbourne, Australia, 90-95) at the University of Massachusetts uses modified keywords and linguistic features. Another approach that has been used is the use of Augmented Transition Networks (ATNs) to score short text answers. These approaches work best when the grammar is constrained, which is not the case in the automated short free-text scoring method and system of the present invention. Models also vary by the objective of assessment: the objective can focus on assessment of knowledge, logical skills, and English language skills. Some approaches address diagnostics of an essay instead of holistic scoring.

To assess how closely a learner's or student's free-text answer resembles the correct answer, statistical methods compare the underlying semantic relationships between two text samples. One widely known statistical system is based on LSA. This approach is described well by Landauer et al (Landauer, T. K., Foltz, P. W., and Laham, D. (1998), “An Introduction to Latent Semantic Analysis”, Discourse Processes, v. 25, p. 259-284). In brief summary, LSA captures the underlying semantic relationships that are expressed in an essay by collecting a very large dataset of word frequencies found in many topic-related documents. Then, by following a statistical process akin to factor analysis, words with similar meaning are grouped. Based on the underlying semantic structure, LSA computes the similarity of a student's answer to a model or correct answer.

Some shortcomings of LSA make it difficult to apply in automated short free-text scoring:
1. LSA becomes effective only over a threshold where the answer size is approximately 200 words or more, i.e. long free-text.
2. Current LSA solutions assume the availability of a centralized corpus (a collection of documents focused on a specified topic that is used in the statistical comparisons of students' answers to the model answer). The basic question is how well will a general purpose corpus work when applied to different specialized domains. What techniques might be used to generate a corpus that addresses a targeted domain, and will they improve scoring accuracy?
3. Most LSA solutions rely on the availability of a large dataset of graded answers.
4. An important component of applying LSA is finding the optimal dimensionality for the final representation.

As described above, the current approaches using LSA appear to work well for content that is relatively lengthy. Rehder et al (Rehder, B., Schreiner, M. E., Wolfe, M. B. W., Laham, D, Landauer, T. K., and Kintsch, W. (1998), “Using Latent Semantic Analysis to assess knowledge: Some technical considerations”, Discourse Processes, v. 25, #2 & 3, p. 337-354) report a series of studies in which they applied LSA to score texts that varied in length by 30 word increments. They looked at the relationship between LSA assessments of the first 30 words of the model answers and the students' answers. The correlations between human scorers and LSA assessments were near 0 for the first 30 words of the passages, and slowly grew to an asymptote value at a little over 200 words. Accordingly, Rehder et al recommend that LSA only be used with passages greater than 200 words.

### SUMMARY OF THE INVENTION

The present invention is generally characterized in an automated short free-text scoring system developed to include instructional material for being presented to a learner, a corpus including a collection of documents related to a specific topic in the instructional material, a model answer to a question about the topic, and means for automatically scoring a short free-text answer composed and submitted by the learner in response to the question. The instructional material includes substantive content about the specific topic and a question about the topic. The substantive content may be presented in a text passage to be read by a learner. The model answer to the question provides a reference against which the learner's answer is compared using an algorithm. The corpus is acquired from focused crawling conducted on the Internet and initiated with a search term corresponding to the specific topic and a search term corresponding to the general domain of the topic to generate sets of web pages that are used to create a text classifier which controls the acquisition of additional web pages. The corpus is represented as an inverted index of the documents therein. The corpus is used in the comparison of two passages or sequences of text for similarity. The inverted index facilitates querying for the appearance of words and word combinations within the corpus. The means for automatically scoring includes means for determining the frequency of words and combinations of words in the documents to determine the semantic similarity of the words, means for applying the semantic similarity determination to compare a passage of text from the learner's answer for semantic similarity with a passage of text from the model answer, and means for allocating a score to the learner's answer in accordance with its semantic similarity to the model answer.

The present invention is further characterized in a method for automated short free-text scoring comprising the steps of presenting instructional material to a learner including substantive content about a specific, and at least one question about the topic presented in a form requiring a short free-text answer composed by the learner; authoring a correct free-text answer to the question; conducting a focused crawl using the Internet to acquire a corpus including a set of documents related to the topic and involving creation of an inverted index of the documents; receiving a short free-text answer composed by the learner in response to the question; and automatically scoring the learner's answer including evaluating the co-occurrence of words in the corpus to determine semantic similarity between words, evaluating the learner's answer for semantic relatedness to the correct answer by matching words in the learner's answer to words in the correct answer, and allocating a score to the learner's answer based on its semantic relatedness to the correct answer.

Various objects, advantages and benefits of the present invention will become apparent from the following description of the preferred embodiment taken in conjunction with the drawings.

### BRIEF DESCRIPTION OF THE DRAWINGS

FIG. 1 is a general illustration depicting the system architecture of the automated short free-text scoring system of the present invention.

### DESCRIPTION OF THE PREFERRED EMBODIMENT

The automated short free-text scoring method and system provide an innovative online assessment tool for development, delivery and automated scoring of free-text and multimedia assessment items and include a variety of assessment types including “open text” answers of various lengths, proprietary text algorithms, online delivery, easy to use authoring, speech synthesis capability and items that can be tailored to specific user domains.

The automated short free-text scoring method and system expand the limited variety of question types commonly available to the instructional designer in online testing environments to include a rich variety of assessment object types, and facilitate importation of new assessment object types that adhere to a simple interface.

The automated short free-text scoring method and system employ an algorithm that is specifically designed to score short free-text answers. The automated short free-text scoring method and system need only a few examples of correct answers to create a free-text assessment object.

In the automated short free-text scoring method and system, learners' free-text answers are scored in reference to both exemplar, model or “correct” answers supplied by the instructional designers or authors and comparison with enabling objectives specified for each learning unit. The automated short free-text scoring method and system may incorporate speech synthesis capability, allowing for auditory presentation of questions using speech synthesis technology, as well as enabling questions where responding to audio input is part of the assessment object. Assessment items are preferably arranged in functional learning units, such as topics, units and exams. The automated short free-text scoring method and system can be easily implemented via deployment to a client server and require only minimal maintenance.

Free-text assessment for which the automated short free-text scoring method and system are used differs from the high-stakes type of testing conducted by ETS in that the context for applying automated free-text assessment in accordance with the present invention is a relatively simple training situation. The present invention provides the instructional designer with a substitute and/or alternative for multiple-choice questions that are traditionally used to check a trainee's comprehension of instructional material. The present invention addresses the difficulties facing the instructional designer in writing good multiple choice test questions that effectively assess whether a trainee has read and comprehended the main idea of a few pages of instructional text. Further, the present invention allows the instructional designer to capitalize on the fact that trainees will likely pay more attention to the content of a passage being read if they have to generate an answer to a question about the passage, rather than simply select an answer from a multiple-choice list. One aspect of the present invention is to give the instructional designer the option of using short free-text measurement that forces the trainee to produce a short free-text answer, without imposing a complicated task on the instructional designer. Preferably, the automated short free-text scoring method and system will allow the instructional designer to create (a) a question about a passage of text, and (b) one correct or model answer to the question. After reading the passage, the learner would compose and submit a short free-text answer to the question. The automated short free-text scoring method and system would assess the learner's understanding of the passage by comparing the learner's short free-text answer to the correct or model answer that was created by the instructional designer.

The aspect of an instructional designer using an automated short free-text scoring method and system to determine or assess a learner's understanding of the passage or acquisition or comprehension of the content of the passage affects the requirements of the scoring method and system. First, the automated short free-text scoring method and system only need to discern relatively simple characteristics of the learner's short free-text answer. To determine if the learner read the passage, the automated short free-text scoring method and system need only assess if the learner's answers indicate that the learner achieved an understanding of the text or passage that corresponds to Bloom's Knowledge and Comprehension level (Bloom, Benjamin (1984), “Taxonomy of Educational Objectives”, Boston: Allyn & Bacon). The scoring method and system need not differentiate short free-text answers that demonstrate basic knowledge but poor analysis (or other higher level understandings). Second, the automated short free-text scoring method and system are not used for high-stakes testing, such as assigning the individual to one job or another. Rather, the testing is used for the relatively low-stakes determination of pacing the learner through an instructional presentation. If the scoring method and system make a mistake and inaccurately “fails” the learner, the learner will have to repeat a section of training unnecessarily. If the scoring method and system inaccurately “passes” a learner, the learner will move on to the next section of the training without fully understanding a previous section. In either case, the inaccurate assessment does not give rise to high-stakes consequences.

The automated short free-text scoring method and system use an algorithm that supports shorter free-text answers and a smaller set of exemplar, model or correct answers than prior free-text assessment methods and systems. The extraction of a corpus that is relevant for the assessment task enhances the quality of the scoring or grading, as the raw semantic content embedded in such a corpus has more token relationships that may be found in the assessed free-text. The Internet can serve as a source for raw text related by semantic content to create a corpus in the automated short free-text scoring method and system. Collecting related documents from the Internet and building inverted indexes of the words in the documents can provide valuable co-occurrence information that captures semantic relatedness. An inverted index is a data structure in which the words are used as keys that link words to a list of documents containing these words. Crawling tools that filter web documents according to domain criteria can enable instructional designers to create their own corpus that is tightly tied to a question or a series of questions on a given topic of assessment or instructional material. Turney (Turney, Peter (2001), “Mining the Web for Synonyms: PMI-IR versus LSA on TOEFL”, In De Raedt, Luc and Flach, Peter, Eds,. Proceedings of the Twelfth European Conference on Machine Learning (ECML-2001), pp. 491-502, Freiburg, Germany) demonstrated the value of the Internet as a source for corpora when he created a tool that solves Test of English as a Foreign Language (TOEFL) exam questions better than LSA by following a set of search engine queries.

While LSA uses matrix manipulation to solve assessment problems, the automated short free-text scoring method and system of the present invention apply a set of queries to an inverted index of harvested web pages. Rather than following Turney's approach of using an existing search engine, in accordance with the present invention indices from the Internet or world wide web are collected and stored locally.

The present invention uses an algorithm whose scores, grading or assessments of short free-text answers correlate well with scores, grades or assessments provided by human scorers, graders or raters. The algorithm, which is referred to herein as Short Answer Measurement of Text (SAMText), addresses two challenges: 1. scoring free-text answers as short as one complete sentence and 2. scoring free-text answers without training the algorithm through (a) a large dataset of sample answers or (b) graded sample answers. Accordingly, the algorithm uses only the following resources in order to perform the scoring: (1) a model or sample answer, (2) a learner's answer, and (3) a domain corpus.

The present invention integrates (a) word matching (including stems), (b) dictionary querying (looking for synonyms), and (c) statistically matching the co-occurrence of terms in similar contexts in a domain-related corpus. The algorithm addresses the challenge presented by short free-text using the following approaches: 1. Corpus—providing an easy method to automatically create a domain specific corpus and to tie it to a question, which helps increase human scoring-machine scoring correlation, and 2. Classification—providing a method to score a learner's short free-text answer by comparing a correct or model answer to the learner's answer.

In the present invention, the domain specific corpus is created using a technique or method known as “focused crawling”. Focused crawling has become an important method for information gathering over the Internet (Chakrabarti, Soumen, van den Berg, Martin, and Dom, Byron E. (1999), “Focused Crawling: A New Approach for Topic-Specific Resource Discovery”, Computer Networks, v. 31:1623-1640). The goal of a focused crawler process is to selectively seek out web pages that are relevant to a pre-defined set of topics. The topics are specified not by using keywords, but by using exemplary documents of the selected topic. The selected web pages can be obtained both manually, or from a search engine. By using the domain-specific corpus, the present invention does not need to access a search engine at the time of assessment.

Web crawlers are automated applications that gather web pages from the Internet. They use an iterative process of following links from a current document to gather more web content/documents. Crawling is widely used by search engines, business intelligence systems, and other intelligence gathering agendas. When the crawling follows a process in which each web page is analyzed for its relevancy to the “gatherer” web page/document, it is called “focused crawling.” In focused crawling, irrelevant web pages are filtered out, and only links from relevant web pages are used to gather additional relevant data. A focused crawler that has a simple text classifier related to a domain of interest is used in the present invention to create a corpus of related documents, i.e. a specialized domain corpus.

The focused crawler of the present invention creates the corpus by implementing the following tasks or process:

1. The user, who may be the instructional designer, describes a search in terms of a specific topic query within a more general domain. For example, the search “elm tree within science” has the specific topic query “elm tree” within the more general domain “science”. In other words, the user specifies a term for the topic of the crawl, i.e. “elm tree” in the present example, and a term for the hypernym (super-subject), i.e. “science” in the present example. The user also specifies the number of “seed” pages (the number of pages to be used to create a text classifier), the number of “threads” (the number of links to be searched at one time), and the maximum number of documents to be acquired in the corpus.

2. The focused crawler goes to Google, for example, and submits two queries: one for the specific topic and one for the general domain hypernym. As a result of these two queries, a set of web pages/documents are generated for the specific topic, i.e. “elm tree” in the present example, and for the general domain hypernym, i.e. “science” in the present example.

3. The document sets resulting from the two queries are used to create a text classifier, which is used to filter the crawl. The text classifier can detect if a document is about a specific topic or not by using a mathematical procedure to categorize documents as being about (a) the specific topic, i.e. “elm tree” in the present example, or (b) the general domain, i.e. “science” in the present example.

4. The original or first resulting document set further serves as the seed set for the crawl. The focused crawler follows the links in the seeds outward, evaluating links according to the classifier to determine which links to follow to various additional web pages/documents to be collected.

5. The crawl ends when no more links are found, when the target corpus size of collected web pages/documents is reached, or when stopped by the user.

6. The collected web pages/documents are indexed, preferably using Lucene, to create an inverted index. The source web pages are discarded.

In the past, little attention was given to corpus selection or creation as a tool to improve assessment performance. The present invention, in contrast, builds a dedicated, focused corpus in the targeted domain that improves assessment performance. The instructional designer or user, using the above-described process, can specify the specific search term and the domain term which should be applied to initiate the focused crawl. Then, the crawler executes the process creating an inverted index for the topic.

The inverted index that is created out of the corpus involves an index structure in which the words are used as keys that link these words to lists of documents containing these words. This inverted index provides a full text, automated search capability from any word to the location of that word in documents. An inverted index is the main data structure used in automated, Internet or computerized search engines. The present invention uses Lucene (an open source library) for the creation and query of an inverted index. The use of a search engine index can help detect synonymy, and may perform better than LSA in some cases. The approach taken by Turney, referred to hereinabove, for evaluating synonymy used a set of queries sent to a search engine. Turney's approach has two main problems: first, the use of a search engine relies on a network access for each query, a process that is inefficient in a production setting relative to creating and storing an inverted index; and second, the use of a general search engine can detect synonymy in general English language, but fails to capture domain related synonymy, or concept relationships. By creating a local indexed corpus of domain related documents, the present invention overcomes these problems.

Valuable co-occurrence information is obtained by using the inverted index of the corpus. Once the corpus with the inverted index is established, a function float match(w1,w2) is developed which returns a number between 0 and 1 indicating the semantic similarity of two words, i.e. words w1 and w2. The higher the number, the greater the semantic similarity between the two words under comparison. Match follows the essence of Turney's PMI-IR method by counting the number of documents in which w1 and w2 appear in proximity to each other, and dividing that number by the total number of times w2 appears in the corpus. Thus, if the number returned for match (w1,w2) is greater than the number returned for match (w3,w2), i.e. match (w1,w2)>match (w3,w2) where w3 is another word that is compared with w2, it can be concluded that w1 is closer or more similar semantically to w2 than is w3. This is aggregated into the following function: word find (w1 sentence) which, given a sentence and a word w1, the function finds a word in the sentence that is most semantically related to w1. This is done by applying the match function to compare w1 with every word in the given sentence. The find aspect of the word find function returns the highest match, i.e. the word in the sentence that is most semantically related to w1, as long as it is larger than the average over a certain value, or returns null if no match was large enough.

In the present invention, the score indicating the semantic relatedness of the model answer and the learner's answer is calculated by how many words (not “stop” words) in the model answer are accounted for in the learner's answer, after considering similarity, synonyms, and stemming. The score is reported after normalizing the score to account for answers of nonstandard size. The use of functions which match words based on similarity, synonyms, and stemming is well suited to capture the Bloom Taxonomy levels of knowledge and comprehension. The algorithm used in the present invention is not built with the intent to differentiate sample texts that differ in higher levels of Bloom's Taxonomy, such as application or analysis, but only to capture the Bloom Taxonomy levels of knowledge and comprehension.

The following describes an example where the present invention was used by researchers acting as instructional designers to create materials including model answers and a corpus, and to score short free-text answers composed by participants acting as learners. The participants had little prior knowledge of the instructional material used for testing, and they had to read the material in order to correctly answer knowledge-based questions about the material. If they did read and understand the material, they should be able to answer the question/questions asked about the material. In this example, the material used for testing was a six-page description of Dutch Elm disease. These pages were extracted from the USDA forestry web site (http://www.na.fs.fed.us/spfo/pubs/howtos/ht_ded/ht ded.htm).

The questions created for the participants to answer after reading the instructional material addressed major points included in the substantive content of the material. The questions created for the particular example were the following:

(1) Question 1: “Why do elm trees with Dutch Elm disease wilt and die?” Participants were given the following beginning of an answer: Elm trees with Dutch Elm disease wilt and die because . . .

(2) Question 2: “How did Dutch Elm disease first come to the United States?” Participants were given the following beginning of an answer: Dutch Elm disease first came to the United States . . . .

The questions require answers in free-text form composed by the participants working off the initial or beginning phrases provided for the answers to the questions. The participants were given the initial phrases of the answers because pilot studies showed unnecessary variability in scoring resulted from some participants repeating the crux of the question in the answer, while others did not. Providing the beginning of the answer prevented unnecessary variability. Both of these questions required knowledge which the participants would have to obtain from reading the instructional material and which could not be derived by guessing. In the present example, the entire process of reading the instructional material and answering the questions was conducted online. Participants began the process by reading the six pages of instructional material on Dutch Elm disease. They read the content, and then answered the two questions presented in the test. If they did not finish with the instructional material in 15 minutes, they were automatically sent to the test questions. Participants then created free-text answers to the two questions presented in the test. In the present example, the participants were not allowed to re-read the instructional material.

As previously described herein, a corpus is a collection of documents focused on a specified topic that is used in the statistical comparisons of learners' answers to the model answer. Researchers in the present example compared the correlation of SAMText scores, i.e. those obtained with the method and system of the present invention, with human raters' scores when using different corpora. The corpora were built or acquired as previously described by a web crawling process or mechanism that finds documents related to the concept underlying the question. As explained above, this web crawling process or mechanism uses two search terms: one, the specific topic, and two, the more general domain or hypernym. Based on these two terms and the search mechanism described previously herein, the researchers in the present example created different corpora based upon the different keywords used to guide the search. The domains were arranged vertically from the general to the specific. Starting with “science” in the present example, specific keywords were used including “biology”, “botany”, “forestry”, “elm trees”, and “Dutch Elm disease”. Although there is a continuum of specificity between the general and the specific subjects, reference is made only to specific locations on this continuum represented as keywords (e.g. “botany”). The various corpora also vary in number of documents included in each collection. The number of documents included in a corpus was 150, 375, 500, 1,000, or 3,000. Corpora built with different keywords as the basis for the search and with different numbers of documents allow for the systematic investigation of corpus attributes that relate to SAMText's performance, compared to trained human scorers.

To determine the accuracy of SAMText scores, its scores must be compared to human scorers, graders or raters. To evaluate SAMText, the correlation of SAMText scores to human raters was compared with the correlations between human raters themselves. SAMText would be considered a good substitute for human raters to the degree that the correlation between SAMText and human raters is similar to the correlation between human raters themselves.

To make this comparison in the present example, four human raters scored or graded all of the participants' answers to the two questions, using model answers to the questions as the “correct” key. To make the comparison between human raters and SAMText equal, the human raters and SAMText were given the same underlying materials: one correct model or answer for each question and instructions to provide scores that expressed the correspondence between the model answer and the participants' answers to the question. In the expected context of use for the present invention, instructional designers would create one model answer, and then assign numbers that correspond to the degree of similarity between the model answer and a learner's answer. In the present example, the human raters were given one model answer, and were expected to assign a number corresponding to the similarity between the model answer and each participant answer. In the present example, participants' answers were rated, scored or graded on a scale of 0 to 5, where 0 represented no knowledge of the correct answer and 5 represented complete knowledge of the correct answer.

The results obtained with the present invention are demonstrated in three experiments conducted using the present example and explained in greater detail below. The first experiment, Experiment 1, demonstrates how corpora built with different keywords and number of documents are used with SAMText to produce scoring results having the greatest similarity to those produced by human raters. The second experiment, Experiment 2, investigates and reports on the correlations between scores from SAMText, using the best corpus, and scores from the human raters, and compares these correlations with the correlations between the scores of the human raters themselves to provide a sensitive measure of the quality of SAMText scoring capability relative to the quality of human scoring. The third experiment, Experiment 3, reports Kappa scores which compare the categorization of SAMText scores with the categorization by human raters. While correlations are more sensitive and not affected by mis-calibrations of score boundaries as Kappa scores are, SAMText is used in practice to assign trainees to simple categories, such as Pass or No-Pass. The results of the third experiment demonstrate how well SAMText categorizes learners' short free-text answers relative to how well human raters categorize learners' short free-text answers.

### Experiment 1: Creating the Best Corpus

When instructional designers create a question to be scored by SAMText, they create a corpus of documents which address the topic of the question (Dutch Elm disease in the present example). As described previously, three parameters define the collection of a corpus: (1) a specific topic keyword, (2) a general domain keyword, and (3) the size of the corpus. This experiment involved an empirical study in which these parameters were systematically varied to find the best corpus for the question.

Pilot studies conducted in other domains (psychopharmacology and social decision making) had found that the SAMText algorithm shows greatest agreement with human raters when the corpus uses a broad general domain keyword, one category or level more specific than the entire Internet, and uses a specific topic keyword, one category or level more general or abstract than the specific topic of the question. Applying the pilot study findings to the current experiment and example presented, SAMText should perform most similar to human raters when the general domain keyword is “science” (one category or level more specific than the entire Internet) and the specific topic keyword is “elm tree” (one category or level more general or abstract than the specific topic of the question, i.e. Dutch elm disease).

In the current experiment, the issue of how to construct the best corpus was approached in the following way. First, the best specific topic keyword was systematically looked for, while using the general domain keyword “science”. The corpora size was set to be 500 words. The relationship or correlation between scores obtained from SAMText and scores obtained from one of the human raters (R1) were compared for three different corpora: corpora where the specific topic keyword is the specific topic of the question, i.e. “Dutch elm disease”, corpora where the specific topic keyword is one level or category more general or abstract, i.e. “elm tree”, than the specific topic of the question, and corpora where the specific topic keyword is two levels or categories more general or abstract, i.e. “forestry”, than the specific topic of the question. Table 1 below summarizes the results of the comparison and indicates the correlations between the SAMText scores and the human rater's scores as a numerical value for each corpus. The higher the numerical value, the greater the correlation between the SAMText scores and the human rater's scores.

TABLE 1
Correlation of SAMText Scores and Scores of One Human Rater
for Corpora Based on Different Specific Topic Keywords

| Specific | Dutch | | |
|---|---|---|---|
| Keyword | elm Disease | elm tree | forestry |
| R1 | .65 | .73 | .55 |

The results from this study are similar to the results from the pilot studies: the specific topic keyword that leads to the highest correlation between SAMText scores and human rater scores was one level or category more abstract or general than the specific topic addressed by the question. In the present example, the specific topic of the question is “Dutch Elm disease”, and one level more abstract is the keyword “elm tree”, resulting in the highest correlation (0.73).

Finding the best general domain keyword to be used in constructing the corpora involves finding the general domain keyword that leads to the highest correlation between SAMText scores and human rater scores. In a further aspect of Experiment 1, the correlations between the SAMText scores and the human rater's scores were compared for two different corpora, each using the best specific topic keyword, i.e. “elm tree”: one corpus where the general domain keyword, i.e. “science”, is one level more specific than the entire Internet and the other corpus where the general domain keyword, i.e. “biology”, is two levels more specific than the entire Internet. The corpora were limited to 500 words each. The results of the comparison are shown below in Table 2, which indicates the correlations between the SAMText scores and the scores of the human rater as a numerical value for each corpus. As previously explained, the higher the numerical value, the greater the correlation.

TABLE 2
Correlation of SAMText Scores and Scores of One Human Rater
for Corpora Based on Different General Domain Keywords

| General | | |
|---|---|---|
| Keyword | science | biology |
| R1 | .73 | .63 |

The results from this study indicate that the best general domain keyword is one level or category more specific than the entire Internet. In the present example, the general domain keyword “science” yielded the highest correlation (0.73).

A further study conducted with respect to corpora construction focused on the size of the corpora. Theoretically, there should be an optimal number of documents in a collection that leads SAMText to assess answers most similar to the assessments made by human raters. If there are too few documents in the corpus, the algorithm is not making use of as many documents as there are available. For example, if the focused crawl collects 50 out of 500 documents on the Internet about elm trees, the corpus will not cover a representative sample of the text available on the topic. Conversely, if there are too many documents in the corpus, the algorithm is basing its ratings on documents that were found with the focused crawl, but which do not really address the topic. These extra, less relevant documents dilute the quality of the documents that address the topic more closely, such that SAMText yields scores having lower correlations with the scores of human raters. The optimal number of documents in a corpus should be an intermediate number of documents, with too few and too many documents in a corpus leading to worse performance. In this study, the best general domain and specific topic keywords (“science” and “elm tree”) were used to create corpora containing different numbers of documents (150, 384, 500, 1000 and 3000 documents, respectively). The correlation between scores obtained from SAMText using the five corpora and scores obtained from the human rater R1 were compared, and the correlations are set forth below in Table 3. The results demonstrated that the corpus containing an intermediate number (384) of documents yielded the highest correlation (0.72) between SAMText scores and the human rater's (R1) scores.

TABLE 3
Correlation of SAMText Scores and Scores of
One Human Rater for Different Size Corpora

| | elm tree | elm tree | elm tree | elm tree | elm tree |
|---|---|---|---|---|---|
| | science | science | science | science | science |
| | 150 | 384 | 500 | 1000 | 3000 |
| R1 | .71 | .72 | .71 | .67 | .64 |
| R2-R4 | .72 | .76 | .78 | .67 | .67 |

A further aspect of this study involved computing and comparing the correlations between scores obtained from SAMText using the five corpora and scores obtained from the other three human raters. The correlations between the SAMText scores and the scores from human rater R2 are set forth above in Table 3. The results again demonstrated that the corpus containing an intermediate number (500) of documents yielded the highest correlation (0.78) followed closely by the corpus composed of 384 documents (0.76). The results from the first human rater were generally consistent with the results obtained from the other three human raters. The relationships between corpora size and the correlations between SAMText scores and the scores of human raters showed the expected inverted-U function. An intermediate size corpus provided the highest correlation between SAMText and human raters, with lower correlations resulting when too few or too many documents are included in the corpus.

### Experiment 2: Comparing SAMText Scores Using the Best Corpus to Scores of Human Raters

After determining from Experiment 1 how to create the best corpus for use with the SAMText algorithm, a primary issue concerns the accuracy of the SAMText algorithm in scoring short free-text answers. To evaluate this issue, Experiment 2 involved determining (a) how well SAMText scores correlate with human raters' scores relative to (b) how well human raters' scores correlate with each other. Table 4 below shows how scores from each rater or scorer, i.e. SAMText and four human scorers or raters S1, S2, S3 and S4, correlate with the average score from the other scorers or raters for questions Q1 and Q2. The correlations are expressed as numerical values, with higher numerical values corresponding to higher correlations.

TABLE 4
Correlation of Scores From Individual Raters--Human
Raters and SAMText--to Scores of Other Raters

| | SAMText - | S1 - | S2 - | S3 - | S4 - |
|---|---|---|---|---|---|
| | Avg human | all other | all other | all other | all other |
| | scorers | scorers | scorers | scorers | scorers |
| Q1 | .78 | .86 | .86 | .90 | .88 |
| Q2 | .74 | .84 | .88 | .90 | .93 |

To evaluate whether or not the SAMText scores were as accurate or “good” as the human raters' scores, it was determined whether or not the SAMText scores fell within a 95% Confidence Interval of the human raters' scores. The rationale for this approach was based on the notion that SAMText scores have no variance, hence, using typical comparisons, such as t-tests which rely on group variance, was inappropriate. The test approach was to see if a SAMText score could be a plausible substitute for human raters' scores. The 95% Confidence Interval for the human raters or scorers was computed. To compute this Confidence Interval, the Fisher r to z transformation was applied, and then the 95% Confidence Interval was calculated, given the four human raters or scorers S1, S2, S3 and S4. For Question 1 (Q1), the score from SAMText was outside the Confidence Interval, but for Question 2 (Q2), the SAMText score was inside the Confidence Interval.

The correlations set forth in Table 4 between the human raters S1, S2, S3 and S4 and “all other scorers” included the SAMText scores in the average scores of “all other scorers”, raising the question of whether the correlations for the human raters S1, S2, S3 and S4 were lowered due to inclusion of the SAMText scores in the average scores of all other scorers. Thus, a further analysis was performed to correlate each of the human rater's scores with the average scores from the other human raters for Question 1 (Q1) and Question 2 (Q2), leaving out the SAMText scores. The results of this analysis are set forth in Table 5.

TABLE 5
Correlation of Scores From Individual Raters--Human
Raters and SAMText--to Scores of Human Raters

| | SAMText - | S1 - | S2 - | S3 - | S4 - |
|---|---|---|---|---|---|
| | human | other | other | other | other |
| | scorers | human | human | human | human |
| | (avg) | scorers | scorers | scorers | scorers |
| Q1 | .78 | .88 | .86 | .91 | .88 |
| Q2 | .74 | .87 | .87 | .91 | .93 |

The correlations between the SAMText scores and the average score of all other raters, i.e. human raters S1, S2, S3 and S4, for questions Q1 and Q2 are the same correlations from Table 4, i.e. 0.78 for Q1 and 0.74 for Q2. The correlations between the scores from each human rater S1, S2, S3 and S4 and the average scores from all other human raters for questions Q1 and Q2 are nearly the same as those where the SAMText scores are included in the average scores from all other raters or scorers. Accordingly, including SAMText as an expert or human equivalent rater or scorer does not affect the results of the correlations.

Table 6 reports the average correlations between individual raters for questions Q1 and Q2. Table 6 is different from Table 5 in that it reports the average correlation between individual raters or scorers, while Table 5 reports the correlation between one rater or scorer and the average scores from a set of other raters or scorers. The correlations between one individual, rater or scorer and the average of many raters should be higher than the average correlations between individual raters because the average scores give a better estimate of the true quality of each answer that is scored, while scores from individual raters include individual errors and biases. The correlations among individual raters reported in Table 6 are useful because researchers commonly present the correlation between one human rater and another human rater, and then present the correlation of an automated rating or grading system to one human rater.

TABLE 6
Average Correlations Between Individual Raters

| | Avg correlation of | average correlations |
|---|---|---|
| | SAMText to each | between individual |
| | human scorer | human scorers |
| Question 1 | .72 | .83 |
| Question 2 | .69 | .85 |

An additional issue addressed by Experiment 2 pertains to how many words in a learner's answer are required in order for SAMText to score it accurately. The answers submitted by the participants for Question 1 had an average of 13.1 words, with 63 participants submitting an answer. The answers submitted by the participants for Question 2 had an average of 5.9 words, with 66 participants submitting an answer. In each case, the answers can be characterized as short free-text answers, as opposed to the relatively lengthy text required for LSA.

### Experiment 3: Comparing SAMText's Categorizations of Scores to Human Raters' Categorization of Scores

Experiment 2 compared the correlations of scores between SAMText and human raters. By way of further explanation, correlations represent the relationships between two sets of scores, which allows a sensitive comparison of relative assessment of scores, and provides an excellent measure of the predictability of one set of scores to another. While correlations are maximally sensitive to accuracy of the raw scoring systems, in the context in which SAMText is applied the outcome of importance is not how well do raw scores from SAMText correlate with human scores, but how closely do the categorizations of the learners' answers correspond between human raters and SAMText. To evaluate this issue, the categorization of learners' scores is analyzed using Cohen's Kappa. It is anticipated that an instructional designer using the present invention will want to categorize learners' scores into categories. The two category labels would be “Pass” and “No Pass” or, alternatively, “Correct” and “Incorrect”. In Experiment 3, the human raters were asked to create example learners' answers, to submit those answers to SAMText, and to then select cut-off scores from SAMText to use in categorizing the learners' answers. For purposes of the experiment, the cut-off score for each rater was set to be the score that came closest to dividing the example answers in half. For human raters R1, R2 and R4, the cut-off score was 2; for human rater R3, the cut-off score was 3. For SAMText, the cut-off score was set to 0.52 (on a range of 0-1).

Cohen's Kappa for the Pass/No Pass distinction between SAMText and human raters or scorers is shown in Table 7 for Questions Q1 and Q2.

TABLE 7
Cohen's Kappa for Pass/No Pass Categorizations

| | SAMText - | | | | |
|---|---|---|---|---|---|
| | human | SAM- | SAM- | SAM- | SAM- |
| | scorers | Text - | Text - | Text - | Text - |
| | (avg) | R1 | R2 | R3 | R4 |
| Question 1 | .64 | .77 | .77 | .54 | .64 |
| Question 2 | .76 | .88 | 88 | .82 | .91 |

The Kappa scores between SAMText and the human raters appear to approximate the Kappa scores between the human raters. For Question 1, SAMText's Kappa score (0.64) was better than the Kappa score (0.54) of one human rater R3, and was equal to the Kappa score (0.64) of another human rater R4. Similar to the test approach taken in Experiment 2, the 95% Confidence Intervals were computed for the Kappa scores. For both Questions 1 and 2, the SAMText Kappa scores fell within the 95% Confidence Intervals.

Instructional learning or training can be improved by developing a process by which instructional designers could incorporate simple, short free-text scoring methods into their instruction. Such a tool will help instructional designers provide questions that force learners/trainees to generate the main idea of content they have just read. For this process to be feasible for use by instructional designers, it has to meet practical considerations of use, as well as being sufficiently accurate even for very short samples of free-text. In response to this need, the present invention was developed to include and integrate a variety of advances in free-text assessment including: (a.) a filtered Internet crawl to find and collect a corpus of documents that address a specific topic or focus within a more general domain, (b.) a scoring algorithm that uses matching criterion that are specifically addressed to the needs of very short free-text samples, and to the requirement for addressing assessment that compares text samples for common knowledge, rather than analysis or higher levels in Bloom's Taxonomy, and (c.) a test of the scoring method and system to see how accurately it assessed short free-text samples relative to human raters. Even with short samples of free-text ranging to less than ten words, the correlations between the scoring obtained with the method and system of the present invention and the scoring of human raters was in the high 0.70 s.

Important constraints recognized for use of the present invention are the following: (a.) the types of questions and answers that the present invention was designed for and tested for are knowledge and comprehension questions (using Bloom's Taxonomy) and (b.) in corpus development, the corpus builder needs to determine how many documents should be included in the corpus. As explained above, experiments determined that there is an inverted U function, such that an intermediate number of documents in the corpus leads to the best performance.

The present invention provides a framework for the creation and delivery of Internet-based or web-based assessments. There are typically two main types of users for the present invention: instructional designers and learners/students/trainees. Instructional designers may use the present invention in order to create assessments for their instructional content, to embed the assessments within the instructional material or courses they design, and to manage the collection of assessment objects into consumable sequences and exams. Learners may use the instructional content created within the present invention as part of their learning activities such as studying a course online, or taking an exam online. Questions can be implemented as an extension of JAVA applet that have a uniform interface that allows running different types of questions within the scope of a single framework.

The types of questions that the present invention supports include those set forth in the following chart:

| Question | | |
|---|---|---|
| Group | Question type | Explanation |
| Text question | Short answer | Open ended question that expects |
| | | a short answer (sentence to short |
| | | paragraph in length) |
| | Long answer | Open ended question that expects |
| | | a longer answer (longer paragraph |
| | | in length) |
| | Title | The student is given a paragraph |
| | | and is asked to give it a title |
| | Acronym | Explain the Acronym |
| | Select text | Read a given text and select part |
| | | that is relevant to a question |
| Image | PickClick | Select a point on a given image that |
| | | corresponds to a question |
| | TextClick | Name parts of an image that |
| | | correspond to a question |
| Relational | Match | Match elements from two lists into |
| | | pairs |
| | Reorder | Set the order of elements in a list |
| Quantity | Slider | Give quantities answer using a slide |
| Audio | SoundClick | Hear a sound and select the |
| | | appropriate sound description or |
| | | follow-up action |
| | SoundText | Hear a sound and write a text |
| | | answer to a prompting question |

Questions can be presented for consumption or use by the learner in various ways including the following:

### 1. Exam—questions can be allocated into an exam, and exams can be assigned to learners and managed through the present invention.

2. Learning Management Systems (LMS) Exam—questions can be allocated into a third party LMS Exam which can be packaged as a Shared Content Object Reference Model (SCORM) compatible Shared Content Object (SCO) and can be consumed accordingly using the third party LMS.
3. Embedded within learning content—questions can be embedded within a third party learning content. As an example, an instructional designer that develops courses using Macromedia can embed the assessment objects within the Macromedia content as resizable drag and drop objects.

### 4. Sharable Content Object (SCO)—a question can itself be a SCO and used by an LMS.

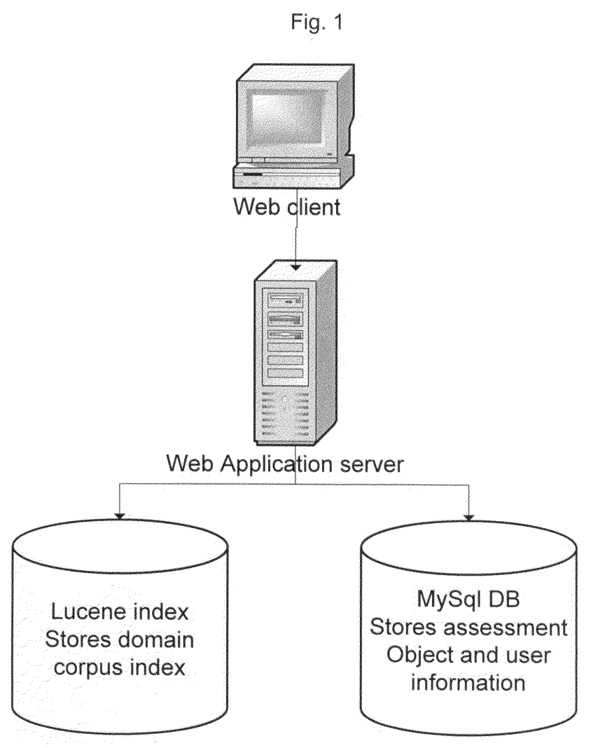

As illustrated in FIG. 1, the present invention is developed as a 3-tier architecture including the following elements:

### Database Tier

MySql for storage of learner/student information and assessment objects.

Lucene for storing the indexed corpus.

### Middle Tier

The logic and management of activities is managed within a web application working under Tomcat.

### Presentation Tier

The content is presented using a thin web client as internet explorer.

The present invention enables use of third party software and libraries.

FREE and open source components are used and relied on.

MySql for database.

Lucene for indexing.

WordNet, and complementing.

Java J2EE for delivery of content.

Jakarta ECS library for dynamic creation of HTML.

Every assessment object type incorporated in the present invention adheres to a presentable interface including interface guidelines to implement a set of activity types. Following the interface guidelines enables new assessment objects to be easily created and incorporated by users/instructional designers into current infrastructure, as well as third party players to run the present invention content, as long as they adhere to the interface guidelines.

The java code of the presentable interface is set forth below:

public interface Presentable {
/** Creates a form for assessing this question.
* @param action String to be inserted to the Action attribute of the form.
* @return Form in ECS format to be added to a html exam.
*/
//get a full form with the test
public Form getTest(String action, String command, String name, String topic);
//get a full form with the training applet
public Form getTrain(String action, String command, String name, String topic);
//HashMap as described in the parameter map of servletrequest
//Test an answer and return a Feedback
public abstract FeedBack test(java.util.Map answer, Map resources);
// friendly name for the presentable to be used in browsers
public String friendlyName( );
//Collect specific information to create this type of question
public void collectInfoLocal(Form f);
// Package the question as a jar file
public byte [ ] jar(Map m);
// validate that the train data inserted by the instructional designer is valid
public void checktraindata(Map resources) throws Exception;
//Set question instance data
public void loadTrainData (Map resources) throws Exception;
// returns the objects needed to operate this Presentable
public Set getObjects ( );
//Create a script for speech synthesis of the question
public String script(byte[ ] jar);
//check if this question uses voice
public boolean isVoiceEnabled( );
//Directions for the instructional designer how to create this type of question
public String trainDirections( );

}

Creation of assessment objects, regardless of their type, is accomplished in the present invention in stages including the following:

1. Select an assessment object type.

2. Input general and specific information:

Name, topic, question text, select if to use voice, upload voice multimedia, input type specific information.

3. Use an applet to give the answer (for example, select area in an image for image question). Add textual feedback to be given to the learner/student when an answer is incorrect.

4. Review the result assessment object and make changes if needed.

The present invention has the ability to manage learners/students and to manage their exams including creation and deletion of learners/students, assigning of exams to learners/students, and viewing exam results by learner/student. There is a separate login for learners/students. When a learner/student logs in, he/she may take an assigned exam, and view results of previously taken exams.

SCORM is a standard for creation and delivery of sharable learning items described at http://www.adlnet.org/. The present invention enables packaging of exams (one or more assessment items) as a SCO (sharable content object), to be consumed using a SCORM compliant learning management system. In order to use SCO, the learning management system has to reside under the same domain as the present invention.

One of the main characteristics of the present invention is the ability to emulate human scoring of free-text answers to open ended questions. In accordance with the present invention, one indexed, domain specific corpus is created that is stored locally or in-house. Accordingly, queries are targeted into a selected domain and not general English. Fast assessment is created as no search engine query is required. Unlike Turney's approach, queries are not sent to a search engine as it is inefficient and uses a general corpus. Moreover, as opposed to Turney's goal to compare words, the present invention compares passages of text for similarity.

Because the corpus is domain specific to the topic, and therefore the substantive content, of the instructional material that is presented to the learner, and is large enough in size to encompass many documents, it is implicit that words in a model answer to a question about the topic/substantive content will appear in the corpus. The algorithm used in the present invention determines the semantic relatedness or similarity between words and combinations of words that appear in the corpus, and evaluates the semantic relatedness or similarity between the learner's answer and the model answer using the semantic similarity determination derived from the corpus. The algorithm compares the learner's answer to the model answer by evaluating the semantic relatedness or similarity of words and combinations of words, i.e. passages or sequences of text, in the learner's answer to words and combinations of words in the model answer.

The main focus of the algorithm used in the present invention is in scoring short answers (a sentence to a short paragraph in length). The algorithm works in two stages:

1. Offline—collection and indexing of a large corpus of text; and

2. Run time—use the collected corpus for comparing two sequences of text.

In the offline process, the goal is to collect a corpus of text of a specified domain that will be relevant to the assessment domain in the use of words and combinations of words that tend to appear together as a base for comparison of text elements. The documents are collected by performing an Internet crawl. As noted above, crawling is an automated process that downloads pages on the Internet, extracts links from downloaded pages and iteratively follows these links. In order to limit the crawl to a target domain, two approaches are taken (selection from the two is done according to the actual domain):

1. Limit the crawl within a selected domain name. For example, limiting the crawl to pages under the domain name “navy.mil” will produce a navy-related domain corpus. In the same way, limiting the crawl to the website of a financial newspaper will produce a financial-related domain corpus.

2. Assess every crawled page as to its resemblance to the selected domain, and follow only links of pages that are assessed as complying with the target domain.

Selection of which documents to follow is done by text classification of the collected documents.

The collected pages are stripped from their html tags, and the core text is indexed using the Lucene indexing software. The outcome of the offline stage is an indexed corpus that enables fast Boolean querying for word and word combination appearances within the corpus.

Using the indexed corpus, fast queries can be performed including: Freq(Word)—retrieves the number of documents in which a word appears in the corpus. Freq(Word1 AND Word2)—retrieves the number of documents in which two words (Word 1 and Word 2) appear together.

### Freq(Word1 NEAR Word2)—retrieves the number of documents in which two words (Word 1 and Word 2) appear together and near each other.

The online or run-time process creates a score, which may be called “words co appearance score”. The words co appearance score is a number that represents the likelihood that a word will appear in the same context.

Considering two words to be assessed: Target word (word that is known)
Option word (word to be checked for synonymy with the target word)
Docnum is the number of documents in the corpus
Freq(word) is the number of documents in the corpus that contain this word

The basic Score function is defined as follows:

$$Score ( Option , Target ) = \frac{Freq ( Option\_And \_Target )}{Freq ( Option )}$$

A refined Score function is defined as follows:

$$Score ( Option , Target ) = \frac{\begin{matrix}Freq ( ( Option\_Near \_Target ) AndNot \\ ( ( Option\_Or \_Target ) NEAR\_ “ Not ” ) )\end{matrix}}{\begin{matrix}Freq ( Option\_AndNot \\ ( Option\_NEAR \_ “ Not ” ) )\end{matrix}}$$

Score measures if two words tend to appear together more than statistically expected. The higher Score is, the more likely the two words are related.

Following this set of rules, it is possible to check which of two words is closer semantically to a target word:

### If Score(Option1, Target)>Score(Option2, Target) we assume that Option1 is closer to Target semantically than Option2.

Using this paradigm, the scoring capability is extended to compare two sequences of text for similarity:

### Correct—Correct textbook answer

### Answer—Answer to be assessed.

Given one word and an answer, the following function finds a matching word in the answer:

### Find (Word, Answer):

1. Score the given word against each word in Answer.

2. Find the word in Answer with the maximum mutual score.

3. If this score is at least twice as high as the average score, return this word as a match, if not, return null.

Using the Score function, two sequences of text can be compared: Compare (Correct, Answer)

1. Iterate words in Correct

2. For each word in Correct, Find (Word, Answer), if a word in Answer was found in a previous iteration, eliminate it from further consideration.

3. If the number of words that were accounted for in Answer is over a certain threshold (70%) return “true”, otherwise, return “false”.

The Compare sequence may be enhanced with inclusion of the following features. Before using the Find( ) function for a pair of words within the Compare( ) sequence, perform the following:

1. Start by comparing words that are actually the same.

2. Don't consider Stopwords¹ We used the following list as stopwords: “A”, “ABOUT”, “AFTER”, “ALL”, “ALREADY”, “ALSO”, “ALTHOUGH”, “ALWAYS”, “AMONG”, “AN”, “AND”, “ANY”, “ARE”, “AS”, “AT”, “BE”, “BECAUSE”, “BEEN”, “BETWEEN”, “BOTH”, “BUT”, “BY”, “COULD”, “DO”, “DOES”, “DURING”, “EACH”, “EITHER”, “FOR”, “FROM”, “FURTHER”, “HAD”, “HAS”, “HAVE”, “HIS”, “HER”, “YOUR”, “HAVING”, “HE”, “HERE”, “HOWEVER”, “MY”, “THEIR”, “IF”, “IN”, “INTO”, “IS”, “IT”, “ITS”, “MAY”, “MORE”, “MOREOVER”, “MOST”, “MUST”, “NO”, “NOT”, “OF”, “OR”, “ON”, “ONLY”, “OTHER”, “OUR”, “SEE”, “SEEN”, “SHOULD”, “SINCE”, “SUCH”, “THAN”, “THAT”, “THE”, “THEIR”, “THEM”, “THEN”, “THERE”, “THEREFORE”, “THESE”, “THEY”, “THIS”, “THOSE”, “THOUGH”, “THROUGH”, “THUS”, “TO”, “WAS”, “WE”, “WERE”, “WHAT”, “WHEN”, “WHERE”, “WHETHER”, “WHICH”, “WHILE”, “WHOSE”, “WILL”, “WITH”, “WITHIN”, “WOULD”, “YES”

3. When comparing words, stem both words to account for different stemming.

4. When comparing words, use a thesaurus, such as the thesaurus java library available for WorldNet 2.0, to find known synonyms, homonyms and hyponyms. Adding another version of rephrased Correct sequence and running Compare( ) on both versions can increase the robustness of the algorithm.

Taking the size of Answer into account can prevent larger answers that attempt to cheat the algorithm. Prior to checking if the number of matches exceeds the threshold, multiply the number of matches with size(Correct)/size(Answer)

In the instructional design stage, an instructional designer creates an assessment object by giving examples of correct and incorrect answers to a question. The instructional designer tests the validity of the assessment object by running the Compare function on an exemplar answer. Once the validation is completed, the question can be used in the testing stage.

In the testing stage, a question is presented to a learner/student using a web delivery platform. The learner's/student's answer is compared to example answers mentioned above using the Compare function. If the Compare function gives a positive result the learner is graded as “Pass”, or “Correct”, otherwise the learner is graded as “Fail” or “Incorrect”.

Scoring can be accomplished or performed using various suitable scoring formats including Boolean scoring and scaled scoring. In Boolean scoring, an answer is scored correct or incorrect according to the threshold mentioned in the Compare sequence. In scaled scoring, a score is obtained for partial grade by using two thresholds in the Compare sequence. Full credit is given if the computation passed the higher threshold, and partial credit is given if it passed the lower threshold. Although partial scoring is possible and available under the present invention, it is not preferred due to fluctuations of grades and the inability to explain why two answers were scored differently.

Inasmuch as the present invention is subject to many variations, modifications and changes in detail, it is intended that all subject matter discussed above or shown in the accompanying drawings be interpreted as illustrative only and not be taken in a limiting sense.

What is claimed I:

1. An automated short free-text scoring system, comprising
instructional material for being presented to a learner including substantive content about a specific topic in a general domain, and at least one question about said topic presented in a form requiring a short free-text answer composed by the learner in response to said question;
a model free-text answer to said question providing a reference against which an answer composed by the learner is compared;
a corpus including a collection of documents related to said topic, said corpus being acquired from focused crawling conducted on the Internet and initiated with a search term corresponding to said specific topic and a search term corresponding to said general domain to generate sets of web pages used to create a text classifier which controls the acquisition of additional web pages in said corpus, said corpus including an inverted index of said documents; and
means for automatically scoring a short free-text answer composed by the learner in response to said question, said means for automatically scoring including means for determining the frequency of words and combinations of words in said documents to determine the semantic similarity of the words, means for applying the semantic similarity determinations to compare a passage of text from the learner's answer for semantic similarity with a passage of text from said model answer, and means for allocating a score to the answer in accordance with its semantic similarity to said model answer.

2. The automated short free-text scoring system recited in claim 1 wherein said substantive content of said instructional material is presented in text form to be read by the learner.

3. The automated short free-text scoring system recited in claim 1 wherein said instructional material further includes a beginning phrase of an answer to said question for being presented to the learner.

4. The automated short free-text scoring system recited in claim 1 wherein said corpus is acquired from said focused crawling initiated with a search term corresponding to said specific topic that is one level more general than said specific topic.

5. The automated short free-text scoring system recited in claim 4 wherein said corpus is acquired from said focused crawling initiated with a search term corresponding to said general domain that is one level more specific than the entire Internet.

6. The automated short free-text scoring system recited in claim 5 wherein the number of said documents in said corpus is intentionally limited in order to optimize the correlation between the score allocated by said means for allocating and a score which an expert human scorer would allocate to the answer.

7. The automated short free-text scoring system recited in claim 1 wherein said means for allocating allocates the score in accordance with the Bloom Taxonomy levels of knowledge and comprehension.

8. The automated short free-text scoring system recited in claim 1 wherein said means for determining includes means for Boolean querying for words and combinations of words within said corpus using said inverted index.

9. The automated short free-text scoring system recited in claim 1 wherein said means for allocating includes means for Boolean scoring of the answer.

10. The automated short free-text scoring system recited in claim 1 wherein said means for allocating include means for scaled scoring of the answer.

11. The automated short free-text scoring system recited in claim 1 wherein said instructional material includes a plurality of questions about said topic, and said automated short free-text scoring system includes one model free-text answer to each of said questions

12. A method for automated short free-text scoring, comprising the steps of
presenting instructional material to a learner including substantive content about a specific topic in a general domain, and at least one question about the topic presented in a form requiring a short free-text answer composed by the learner in response to the question;
authoring a correct free-text answer to the question;
conducting a focused crawl using the Internet to acquire a corpus including a set of documents related to the topic, said step of conducting including specifying a search term corresponding to the specific topic, specifying a search term corresponding to the general domain, retrieving a set of web pages for each search term, creating a text classifier from the sets of web pages, using the text classifier to select links from the sets of web pages to additional web pages to be retrieved, and creating an inverted index of the documents;
receiving a short free-text answer composed by the learner in response to the question; and
automatically scoring the learner's answer, said step of scoring including evaluating the co-occurrence of words in the corpus to determine the semantic similarity between words, evaluating the learner's answer for semantic relatedness to the correct answer by matching words in the learner's answer to words in the correct answer, and allocating a score to the learner's answer based on its semantic relatedness to the correct answer.

13. The method recited in claim 12 wherein said steps of presenting, receiving and scoring are performed online via a computer.

14. The method recited in claim 12 wherein said step of creating an inverted index includes creating the inverted index using Lucene.

15. The method recited in claim 12 wherein said step of evaluating the co-occurrence of words in the corpus includes comparing pairs of words for semantic similarity.

16. The method recited in claim 12 wherein said step of evaluating the learner's answer includes matching words in the learner's answer to words in the correct answer based on similarity, synonymy and stemming.

17. The method recited in claim 12 wherein said step of allocating includes allocating a correct score to the learner's answer when the learner's answer satisfies the Bloom Taxonomy levels of knowledge and comprehension.
